(19) United States
(12) Patent Application Publication
(10) Pub. No.: US 2025/0282233 A1
(43) Pub. Date: Sep. 11, 2025

(54) Method and Device for Controlling Hill Parking of Vehicle, Controller, Vehicle, and Product

(71) Applicant: Robert Bosch GmbH, Stuttgart (DE)

(72) Inventors: Haiqiang Qiu, Wuxi (CN); Xiaolong Cui, Wuxi (CN); Tienan Huang, Wuxi (CN)

(21) Appl. No.: 19/067,920

(22) Filed: Mar. 2, 2025

(30) Foreign Application Priority Data
Mar. 11, 2024 (CN) 2024 1027 6311.4

(51) Int. Cl. B60L 15/20

(52) U.S. Cl. CPC B60L 15/2018; B60L 2240/14; B60L 2240/26; B60L 2240/423; B60L 2240/642; B60L 2250/10

(57) ABSTRACT

A method and device for controlling hill parking of a vehicle, a controller, the vehicle, and a product are disclosed. The method includes (i) determining a torque for controlling the vehicle based on a weight of the vehicle and an angle of a hill on which the vehicle is located, (ii) generating a torque request for a first drive motor of the vehicle and a zero rotational speed control request for a second drive motor of the vehicle based on the torque, and (iii) controlling hill parking of the vehicle with the first drive motor and the second drive motor in response to the torque request and the zero rotational speed control request. In this way, two drive motors may be utilized to provide a greater range of drive forces to the vehicle located on the hill to prevent vehicle slipping, thereby further increasing the safety and convenience of the vehicle during startup in a hill environment and improving the safety of vehicle during hill traveling.

This application claims priority under 35 U.S.C. § 119 to application no. CN 2024 1027 6311.4, filed on Mar. 11, 2024 in China, the disclosure of which is incorporated herein by reference in its entirety.

The examples of the present disclosure generally relate to the technical field of vehicle control, in particular to a method and a device for controlling hill parking of a vehicle, a controller, the vehicle, and a product.

### BACKGROUND

With the rapid development of society, users are increasingly demanding the safety of their transportation mechanisms. As a mainstream tool for users to travel, the safety of the passenger vehicle is naturally receiving increasing attention. In the traveling process of the vehicle, hill parking and hill startup are some of the more common conditions of vehicle traveling.

When the vehicle stops on a road with a slope and starts to start, it often slips after a brake pedal is released due to a large angle of the hill or a time deviation between releasing the brake pedal and pressing an accelerator pedal, which may lead to accidents in serious cases.

### SUMMARY

Embodiments of the present disclosure provide a method and device for controlling hill parking of a vehicle, a controller, the vehicle, and a product.

In a first aspect of the present disclosure, a method for controlling hill parking of a vehicle is provided. The method comprises: determining a torque for controlling the vehicle based on a weight of the vehicle and an angle of a hill on which the vehicle is located. The method further comprises: generating a torque request for a first drive motor of the vehicle and a zero rotational speed control request for a second drive motor of the vehicle based on the torque. The method further comprises: controlling hill parking of the vehicle with the first drive motor and the second drive motor in response to the torque request and the zero rotational speed control request.

In a second aspect of the present disclosure, a device for controlling hill parking of a vehicle is provided. The device comprises a torque determination unit configured to determine a torque for controlling the vehicle based on a weight of the vehicle and an angle of a hill on which the vehicle is located. The device further comprises a torque request generation unit configured to generate a torque request for a first drive motor of the vehicle and a zero rotational speed control request for a second drive motor of the vehicle based on the torque. The device further comprises a hill parking control unit configured to control hill parking of the vehicle with the first drive motor and the second drive motor in response to the torque request and the zero rotational speed control request.

In a third aspect of the present disclosure, a controller is provided. The controller comprises one or more processors; and a storage device for storing one or more programs, the one or more programs, when executed by the one or more processors, causing the one or more processors to implement a method provided according to the first aspect of the present disclosure.

According to a fourth aspect of the present disclosure, a vehicle is provided, the vehicle comprising the controller according to the third aspect of the present disclosure.

In a fifth aspect of the present disclosure, a machine-readable storage medium is provided. The machine-readable storage medium has machine-executable instructions stored thereon, wherein the machine-executable instructions are executed by a processor to implement the method provided according to the first aspect of the present disclosure.

According to a sixth aspect of the present disclosure, a computer program product is provided, the computer program product being tangibly stored on a non-volatile computer-readable medium and comprising machine-executable instructions, the machine-executable instructions, when executed, causing a machine to execute steps of the method according to the first aspect of the present disclosure.

It shall be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 illustrates a schematic diagram of an example environment in which an apparatus and/or method according to some examples of the present disclosure may be implemented;

FIG. 2 shows a flow chart of a method for controlling hill parking of a vehicle according to some examples of the present disclosure;

FIG. 3 shows a schematic diagram of a stress situation of a vehicle on a hill according to some examples of the present disclosure;

FIG. 4 shows a schematic diagram of a process for conducting hill parking control and updating a weight of the vehicle according to some examples of the present disclosure;

FIG. 5 shows a schematic diagram of an iterative process for conducting hill parking control and updating the weight of the vehicle according to some examples of the present disclosure;

FIG. 6 shows a block diagram of a device for controlling hill parking of a vehicle according to some examples of the present disclosure; and

FIG. 7 shows a schematic block diagram of an example apparatus according to some examples of the present disclosure.

In all figures, like or similar reference numerals represent like or similar elements.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “including but not limited to”. The term “based on” should be understood as “at least partially based on”. The term “one example” or “this example” should be understood as “at least one example”. The terms “first”, “second”, etc. may refer to and represent different or the same object. Other explicit and implicit definitions may be included below.

As noted above, when the vehicle is started up on the hill, a user releases a hand brake and a brake pedal of the vehicle and depresses a throttle pedal. During a time interval (e.g., 1 s) from release of the brake pedal to stepping down the throttle pedal, a vehicle may slip forward or slip backward due to the stoppage of a brake force and the fact that the vehicle is affected by gravity. The problem of vehicle slipping may lead to traffic accidents, thereby causing certain injuries to personal safety and damages to property of users.

In relevant techniques, in order to prevent the occurrence of vehicle slipping, a drive motor of the vehicle may be utilized to provide the vehicle with a drive force required to prevent slipping. For example, a component of the gravity of the vehicle on the hill may be balanced by providing a torque by the drive motor to prevent the vehicle from slipping forward or backward. However, when the hill on which the vehicle is located has a larger slope or the weight of goods loaded on the vehicle is heavy, a single drive motor cannot provide the drive force required by hill parking of the vehicle, and it cannot avoid the occurrence of slipping, thereby reducing the safety of vehicle traveling.

To this end, the examples of the present disclosure provide a method for controlling hill parking of a vehicle, the method including: determining a torque for controlling the vehicle based on a weight of the vehicle and an angle of a hill on which the vehicle is located. The method further comprises: generating a torque request for a first drive motor of the vehicle and a zero rotational speed control request for a second drive motor of the vehicle based on the torque. The method further comprises: controlling hill parking of the vehicle with the first drive motor and the second drive motor in response to the torque request and the zero rotational speed control request.

In this way, two drive motors can be used to provide a greater range of drive force for hill parking of the vehicle to ensure that when the vehicle is in a heavy-loaded (or overloaded) state or the vehicle is on a skewed hill, sufficient drive forces can also be provided to the vehicle to prevent vehicle slipping, thereby further increasing the safety and convenience of the vehicle during startup in the hill environment and improving the safety of vehicle during hill driving. At the same time, because the drive modes of the two drive motors are different, there will be no conflict in the control of the vehicle, thereby avoiding increasing the slip distance of the vehicle on the hill and ensuring the safety during hill driving.

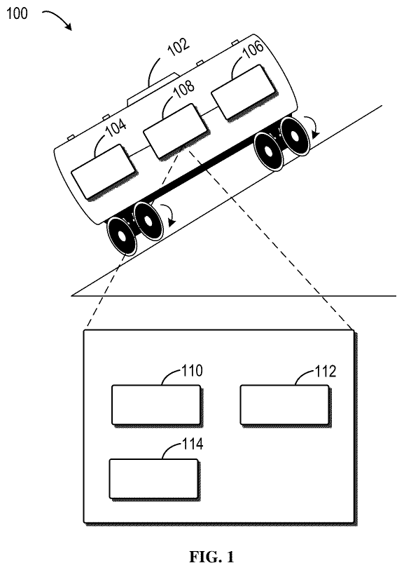

FIG. 1 illustrates a schematic diagram of an example environment 100 in which an apparatus and/or method according to some examples of the present disclosure may be implemented. As shown in FIG. 1, the example environment 100 comprises a vehicle 102, a first drive motor 104, a second drive motor 106, and a controller 108 disposed in the vehicle. According to an example of the present disclosure, vehicle 102 refers to any type of motorized or non-motorized vehicle capable of carrying a person and/or item and capable of moving. As shown in FIG. 1, vehicle 102 is illustrated as an electric vehicle. It should be understood that the vehicle may also comprise other types, such as trucks, cranes, motorcycles, and the like. As shown in FIG. 1, vehicle 102 is located on a hill (an uphill in FIG. 1).

In some examples, a drive type of vehicle 102 may be dual-axis drive. The first drive motor 104 may provide a drive force for a front axle of vehicle 102, and the second drive motor 106 may provide a drive force for a rear axle of vehicle 102. The first drive motor 104 and the second drive motor 106 are electrical devices that can convert electrical energy into mechanical energy, thereby providing a drive force for the vehicle to travel, which may also have the function of converting mechanical energy into electrical energy. The first drive motor 104 and the second drive motor 106 may receive an instruction sent by the controller 108 and adjust their own rotational speeds and output torques according to the instruction to provide a drive force for crawling, accelerated speed, constant speed, decelerated speed, etc. of vehicle 102.

In some examples, the first drive motor 104 and the second drive motor 106 generally have three control modes, for example, a speed control mode, a torque control mode, and a position control mode. The speed control mode refers that an external output torque of the drive motor is set by an input of an external analog quantity or an assigned value of a direct address. The speed control mode refers that the rotational speed of the drive motor may be controlled by input or a pulse frequency to adjust the size of a torque output by the drive motor.

In some examples, the controller 108 may be integrated in a domain controller of vehicle 102 or may be disposed in vehicle 102 as a separate module. For example, the controller 108 may be a vehicle control unit (VCU). It will be understood that the controller 108 is able to utilize a first drive unit 104 and a second drive unit 106 to control the hill parking of the vehicle to prevent vehicle 102 from slipping backward within the period when the driver releases the brake pedal and the hand brake of vehicle 102 and depresses the throttle pedal to start the vehicle.

As shown in FIG. 1, at block 110, the controller 108 may determine a torque for controlling vehicle 102 based on the weight of vehicle 102 and the angle of the hill on which vehicle 102 is located. In block 112, the controller 108 may generate a torque request for the first drive motor 104 and a zero rotational speed control request for the second drive motor 106 based on the torque. In block 114, the controller 108 may control hill parking of vehicle 102 with the first drive motor 104 and the second drive motor 106 in response to the torque request and the zero rotational speed control request. For example, the first drive motor 104 may output the torque indicated by the torque request upon receipt of the torque request; the second drive motor 106 may control wheels (e.g., a rear left wheel and a rear right wheel in the rear axle) at a rotational speed of zero upon receipt of the zero rotational speed control request and output the corresponding torque. It should be understood that the torques output by the first drive motor 104 and the second drive motor 106 may enable vehicle 102 to stabilize on the hill for a period of time to ensure that vehicle 102 can start smoothly without slipping forward or backward.

It should be understood that the two drive motors (the first drive motor 104 and the second drive motor 106) is capable of providing a drive force that matches the slope and the weight of the vehicle, such that vehicle 102 is capable of resting on the hill after a short distance of rearward slipping after the vehicle speed drops to zero. When the driver needs to advance again, only the throttle needs to be stepped down again, and vehicle 102 can proceed after the drive force provided by the two drive motors overcomes a frictional force and the component of the gravity under the current hill. Moreover, the control mode of the first drive motor 104 and the control mode of the second drive motor 106 are different, and there is no conflict or delay in processing time during the process of controlling the first drive motor 104 and the second drive motor 106.

In this way, two drive motors can be used to provide a greater range of drive force for hill parking of the vehicle to ensure that when the vehicle is in a heavy-loaded (or overloaded) state or the vehicle is on a skewed hill, sufficient drive forces can also be provided to the vehicle to prevent vehicle slipping, thereby further increasing the safety and convenience of the vehicle during startup in the hill environment and improving the safety of vehicle during hill driving. At the same time, because the control modes of the two drive motors are different, there will be no conflict in the control of the vehicle, thereby avoiding increasing the slip distance of the vehicle during startup on the hill and ensuring the safety during hill driving.

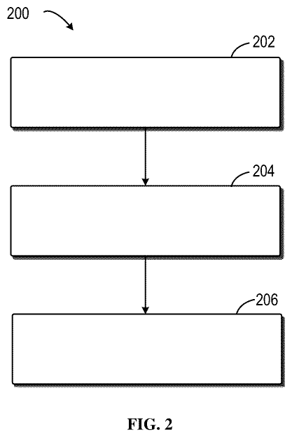

The process according to examples of the present disclosure will be described in detail below in conjunction with FIG. 2 to FIG. 7. For ease of understanding, the specific data mentioned in the following description are exemplary and are not used for defining the scope of protection of the present disclosure. It will be understood that the examples described below may also comprise additional actions not shown and/or actions that may be omitted as shown, the scope of the present disclosure being not limited in this regard.

FIG. 2 shows a flow chart of a method 200 for controlling hill parking of a vehicle according to some examples of the present disclosure. In some examples, the method 200 may be performed by the controller 108 shown in FIG. 1. It will be understood that the method 200 may also comprise additional actions not shown and/or actions that may be omitted as shown, the scope of the present disclosure being not limited in this regard.

As shown in FIG. 2, at block 202, the torque for controlling the vehicle is determined based on the weight of the vehicle and the angle of the hill on which the vehicle is located. The weight of the vehicle is a sum of the weight of the vehicle itself and the weight of the load. The weight of the vehicle may be obtained from a memory of the vehicle or from other network devices connected to the vehicle. For example, the weight of the vehicle may be 4 t, 5 t, etc. In some examples, the hill on which the vehicle is located may be either an uphill or a downhill. The angle of the hill may be a slant angle of the hill, e.g., may be an included angle between a slope of the hill and a horizontal plane. In some examples, the angle of the hill may be 15°, 18°, 20°, etc.

In some examples, the torque refers to a driving moment output by the drive motor from a crankshaft end. Under conditions of fixed power, the torque is inversely related to the rotational speed of the drive motor, i.e., the faster the rotational speed, the smaller the torque. The torque reflects, to some extent, a load capacity of the vehicle within a certain range. The torque generated by the drive motor is transmitted to drive wheels through a transmission system to produce the driving moment. The drive wheels apply a peripheral force to the ground with the driving moment, and the ground's reaction force to the drive wheels is the drive force.

As shown in FIG. 2, at block 204, the controller may generate a torque request for the first drive motor and a zero rotational speed control request for the second drive motor based on the torque. The torque request is used for indicating a first torque expected to be output from the first drive motor. In some examples, upon determining the torque for controlling the vehicle, a portion of the torque may be assigned to the first drive motor, which is in the charge of the first drive motor. For example, the required size of the torque of the first drive motor may be determined based on a preset distribution coefficient. The preset distribution coefficient may be set by the user according to the actual application, for example, it can be set as 0.5, 0.4, 0.45, etc. In one example, the first torque indicated in the torque request is 500 Nm in case that the torque for controlling the vehicle is 1000 Nm and the preset distribution coefficient is 0.5. That is, a fixed torque expected to be output by the first drive motor is 500 Nm.

In some examples, zero rotational speed control refers to setting rotational speed instructions of the second drive motor to zero, a drive force required to prevent hill slipping is adjusted by a proportional integration (PI) module to determine a final execution torque of the second drive motor. The PI module is a linear controller that forms a control deviation according to a given value and an actual output value, and forms a control amount of the ratio and integration of the deviation through a linear combination, so as to control a controlled object.

With continued reference to FIG. 2, at block 206, hill parking of the vehicle is controlled with the first drive motor and the second drive motor in response to the torque request and the zero rotational speed control request. For example, in response to the torque request, the first drive motor may output the first torque indicated by the torque request. In response to the zero rotational speed control request, the second drive motor may output a second torque such that the rotational speed is zero. The vehicle may be controlled based on the first torque and the second torque such that the vehicle does not slip (e.g., slip forward or backward) during startup on the hill. In some examples, the first drive motor may utilize a feedback control system to achieve precise control of torque. For example, the first drive motor may monitor a rotational speed, position, or torque of the load and be compared to a preset target value (e.g., a value of the first torque indicated in the torque request). Based on a comparison result, the first drive motor may adjust its current to output a desired first torque.

In this way, two drive motors can be used to provide a greater range of drive force for hill parking of the vehicle to ensure that when the vehicle is in a heavy-loaded (or overloaded) state or the vehicle is on a skewed hill, sufficient drive forces can also be provided to the vehicle to prevent vehicle slipping, thereby further increasing the safety and convenience of the vehicle during startup in the hill environment and improving the safety of vehicle during hill driving. At the same time, because the drive modes of the two drive motors are different, there will be no conflict in the control of the vehicle, thereby avoiding increasing the slip distance of the vehicle during startup on the hill and ensuring the safety during hill driving.

In some examples, in order to enable the vehicle to be parked on a hill or not to slip during startup on the hill, it is desirable to provide a drive force for the vehicle to overcome the component of the gravity of the vehicle in the hill direction as well as the hill resistance. That is, the drive motor needs to provide a certain driving moment to balance the component of the gravity of the vehicle on the hill and the hill resistance to keep the vehicle stationary. So, the driving moment required to be provided by the drive motor also changes as the weight of the vehicle and the angle of the hill change. In order to ensure that the drive motor of the vehicle is capable of providing sufficient driving moment for hill parking of the vehicle, two drive motors can be utilized to provide the driving moment for the control of hill parking of the vehicle at the same time.

In general, the vehicle is loaded with cargoes and the weight of the cargoes varies from vehicle to vehicle. As a result, the weight of the vehicle stored at the memory or other network devices may not be accurate, further resulting in the determined torque being inaccurate, and it is prone to occurring vehicle slipping if torque control is performed according to the torque. In this case, a portion of the torque may be assigned to one of the two drive motors (e.g., the first drive motor) which is in charge of providing the portion of the torque. In order to ensure that another drive motor (e.g., the second drive motor) is capable of providing the torque required for preventing vehicle slipping, zero rotational speed control may be performed on the other drive motor. That is, torque control can be performed on one drive motor and speed control can be performed on the other drive motor.

In a practical application, the weight of cargoes loaded on the vehicle may be constantly updated, thereby resulting in inaccurate vehicle weight obtained from the memory of the vehicle. Thus, in some examples, upon completion of control of hill parking of the vehicle, the actual weight of the vehicle may be determined according to the torques output by the first drive motor and the second drive motor. The previously stored weight of the vehicle is deleted and the actual weight obtained is stored in the memory of the vehicle, so that when hill parking control is performed on the vehicle subsequently, the updated vehicle weight can be directly called, and the control accuracy of hill parking of the vehicle is higher.

In some examples, upon completion of the control of hill parking of the vehicle, the vehicle may be subjected to stress analysis, and the actual weight of the vehicle is determined in accordance with the Newton's second law. For example, the actual weight mi of the vehicle may be calculated using Formula (1).

$${T}_{1} / r + {T}_{2} / r - {m}_{1} g sin θ = {m}_{1} a \qquad ( 1 )$$

In the formula, T₁ is the first torque output by the first drive motor, T₂ is the second torque output by the second drive motor, and r is the radius of the vehicle. a is the accelerated speed of the vehicle after completion of hill parking control. In some examples, the first torque T₁ output by the first drive motor may be determined based on the torque feedback from the first drive motor. The second torque T₂ output by the second drive motor is determined according to the torque actually output after zero rotational speed control is performed on the second drive motor.

It should be understood that in some examples, in order to further improve the accuracy of the actual weight of the vehicle, the effects of air resistance, rolling resistance, frictional force, etc. may also be considered during stress analysis of the vehicle. The actual weight of the vehicle determined by this method is more in line with the actual situation and more accurate.

In some examples, the actual weight of the vehicle may also be determined based on the initial state when the vehicle is started on the hill and the state after the vehicle completes hill parking control. For example, the actual weight of the vehicle may be determined according to an initial kinetic equation when the vehicle is started on the hill and a kinetic equation after the vehicle completes hill parking control. It is to be noted that when the actual weight of the vehicle is determined, it may be assumed that the frictional force borne by the vehicle or other resistances, etc. are not changed. The initial kinetic equation when the vehicle is started on the hill is:

$${F}_{1} - f = {m}_{1} {a}_{1} \qquad ( 2 )$$

The kinetic equation after the vehicle completes hill parking control is:

$${F}_{2 -} f = {m}_{1} a \qquad ( 3 )$$

Formula (4) is obtained by subtracting formula (2) from formula (3).

$${F}_{1 -} {F}_{2} = {m}_{1} ( {a}_{1 -} a ) \qquad ( 4 )$$

a₁ and a are the accelerated speed of the vehicle when the vehicle is started on the hill and the accelerated speed of the vehicle after the vehicle completes hill parking control. F₁ is the drive force applied by the drive motor (e.g., the first drive motor and the second drive motor) when the vehicle is started on the hill, and F₁ is the drive force applied by the drive motor after the vehicle completes hill parking control.

It will be understood that the drive force (e.g., F₁, F₂) may be read directly from the controller of the vehicle or may be calculated based on the torques output by the first drive motor and the second drive motor. So, in case that a₁, a, F₁, F₂ are determined, the actual weight mi of the vehicle may be calculated directly according to Formula (4).

In some examples, it is desirable that the torque provided to the vehicle by the drive motor before hill parking control is performed on the vehicle is capable of making the vehicle stationary on the hill without slipping forward or backward. Based on this, the drive force for controlling the vehicle may be determined according to vehicle dynamics, thereby determining the torque for controlling the vehicle. In some examples, the drive force for controlling the vehicle may be determined based on the accelerated speed of the vehicle and the component of gravity borne by the vehicle in the hill direction. For example, the drive force F for controlling the vehicle may be calculated using F=mg sin θ. m is the weight of the vehicle, and θ is the inclined plane of the hill.

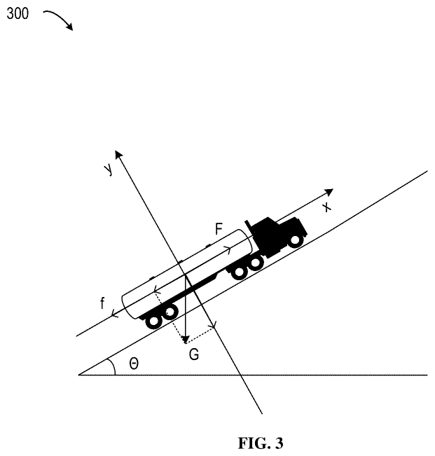

In some other examples, the vehicle is parked on the hill under various forces, such as gravity, frictional force, drive force, etc. To determine a more accurate drive force for controlling the vehicle, comprehensive analysis of the force borne by the vehicle may be performed. FIG. 3 shows a schematic diagram of a stress situation of a vehicle on a hill according to some examples of the present disclosure. The gravity G borne by the vehicle may be exploded in the x-axis direction and the y-axis direction to determine a component of the gravity borne by the vehicle in the x-axis direction and a component of the gravity borne by the vehicle in the y-axis direction. f is the hill resistance borne by the vehicle. The hill resistance may comprise wind resistance, acceleration resistance, and rolling resistance, among others. The drive force corresponding to the torque output by the first drive motor and the second drive motor is F. At this time, the vehicle is in a stress balance state, and the kinetic equation of the vehicle is: F=f+mg sin θ. Upon determining the angle of the hill and the hill resistance f, a more accurate drive force F is determined.

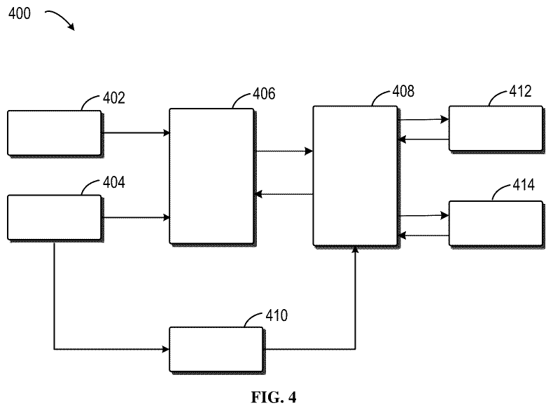

FIG. 4 shows a schematic diagram of a process for conducting hill parking control and updating a weight of the vehicle according to some examples of the present disclosure. As shown in FIG. 4, the weight of the vehicle 402 and the initial accelerated speed 404 of the vehicle on the hill may be read from the memory of the vehicle. The weight 402 of the vehicle stored in the memory may be the initial vehicle weight of the vehicle set by the manufacturer when the vehicle leaves the factory or the weight of the vehicle updated after previous hill parking control is performed on the vehicle. The weight 402 of the vehicle and the initial accelerated speed 404 of the vehicle on the hill are input into a weight calculation module 406 and input into a hill hold module 408 by the weight calculation module 406. It will be understood that upon inputting the weight 402 of the vehicle and the initial accelerated speed 404 of the vehicle on the hill to the weight calculation module, the weight calculation module does not need to process the weight 402 of the vehicle and may directly input the weight 402 of the vehicle to the hill hold module 408. In some examples, the hill hold module 408 may be disposed in the controller of the vehicle (e.g., the controller 106 shown in FIG. 1).

As shown in FIG. 4, the initial accelerated speed 404 of the vehicle on the hill may also be input to an angle calculation module 410. The angle calculation module 410 may determine the angle of the hill using θ=arcsin (a/g). The angle calculation module 410 may then input the calculated angle to the hill hold module 408. The hill hold module 408 may determine a torque for controlling the vehicle based on the weight 402 of the vehicle and the angle of the hill. Based on the torque, the torque request for the first drive motor 412 of the vehicle is generated, the torque request is input to the first drive motor 412, the first drive motor 412 may perform torque control in response to the torque request to output the first torque to control the vehicle. The first drive motor 412 may feed back the outputted first torque to the hill hold module 408.

With continued reference to FIG. 4, the hill hold module 408 may also generate a zero rotational speed control request for the second drive motor 414 based on the torque and input the zero rotational speed control request to the second drive motor 414. The second drive motor 414 may perform speed control in response to the zero rotational speed control request and output a second torque required to cause the rotational speed to be zero. The second drive motor 414 may feed back the outputted second torque to the hill hold module 408. After determining the first torque and the second torque, the hill hold module 408 may input the first torque and the second torque to the weight calculation module 406, and the weight calculation module 406 may utilize a weight determining method described above to determine the actual weight of the vehicle based on the first torque, the second torque, and the initial accelerated speed 404. It will be understood that the weight calculation module 406, upon determining the actual weight of the vehicle, may store the actual weight in the memory of the vehicle and delete the previously stored weight 402 of the vehicle to complete the update of the weight of the vehicle.

In this way, two drive motors can be used to provide a greater range of drive force for hill parking of the vehicle to ensure that when the vehicle is in a heavy-loaded (or overloaded) state or the vehicle is on a skewed hill, sufficient drive forces can also be provided to the vehicle to prevent vehicle slipping, thereby further increasing the safety and convenience of the vehicle during startup in the hill environment and improving the safety of vehicle during hill driving. At the same time, because the drive modes of the two drive motors are different, there will be no conflict in the control of the vehicle, thereby avoiding increasing the slip distance of the vehicle during startup on the hill and ensuring the safety during hill driving. In addition, upon completion of hill parking control of the vehicle, the actual weight of the vehicle may be determined according to the torque actually output by the two drive motors. In this way, on one aspect, the actual weight of the vehicle determined is more accurate, and on other aspect, auxiliary conditions may also be provided for hill parking control of the next vehicle.

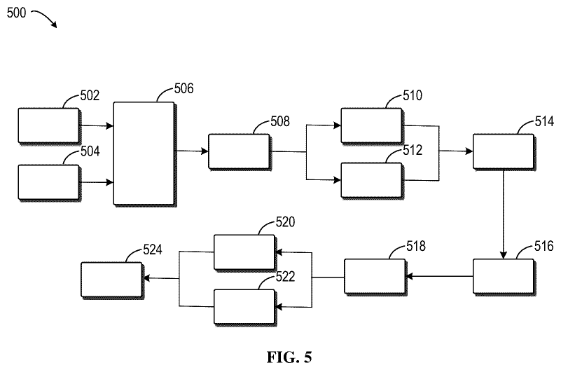

FIG. 5 shows a schematic diagram of an iterative process for conducting hill parking control and updating the weight of the vehicle according to some examples of the present disclosure. As shown in FIG. 5, at block 506, the torque for controlling the vehicle may be determined according to the weight 502 of the vehicle and the angle 504 of the hill on which the vehicle is located. For example, a drive force for controlling the vehicle may be calculated using F=mg sin θ, and the torque for controlling the vehicle is determined according to the drive force. m is the weight 502 of the vehicle, and θ is the angle 504 of the hill on which the vehicle is located. At block 508, the torque assigned to the first drive motor is determined based on the torque and the preset distribution coefficient. At block 510, the torque request for the first drive motor may be generated based on the torque assigned to the first drive motor and sent to the first drive motor. The first drive motor may output a corresponding first torque in response to the torque request. At block 512, in order to ensure that the second drive motor is capable of providing a sufficient torque to prevent the vehicle from slipping on the hill, a zero rotational speed control request for the second drive motor may be generated and transmitted to the second drive motor. The second drive motor may output a corresponding second torque in response to the zero rotational speed control request. The torque provided by the first drive motor and the second drive motor may complete first control of hill parking of the vehicle.

As shown in FIG. 5, at block 514, the actual weight of the vehicle may be determined based on the first torque and the second torque and stored in the memory of the vehicle to update the weight of the vehicle. At block 516, in the process of second control of hill parking of the vehicle, the updated weight of the vehicle may be read and the torque for controlling the vehicle is determined based on the updated weight of the vehicle. At block 518, the torque assigned to the first drive motor is determined based on the torque and the preset distribution coefficient. At block 520, the torque request for the first drive motor may be generated based on the torque assigned to the first drive motor and sent to the first drive motor. The first drive motor may output a corresponding first torque in response to the torque request. At block 522, the zero rotational speed control request for the second drive motor may be generated and sent to the second drive motor. The second drive motor may output a corresponding second torque in response to the zero rotational speed control request. The torque provided by the first drive motor and the second drive motor may complete second control of hill parking of the vehicle.

It will be understood that as shown in FIG. 5, at block 524, in order to ensure that vehicle slipping does not occur in the process of hill parking control of the vehicle on the hill, after hill parking control is performed on the vehicle, it can be detected whether the accelerated speed of the vehicle is greater than the preset accelerated speed. If it is less than the preset accelerated speed, normal control of hill parking can be carried out on the vehicle; if it is greater than the preset accelerated speed, it can return an exception alert message and alert the user that the problem occurs.

In this way, in case that the weight of the vehicle is not so accurate, two drive motors can also provide a greater range of drive force for hill parking of the vehicle to prevent vehicle slipping, thereby further increasing the safety and convenience of the vehicle during startup in the hill environment and improving the safety of vehicle during hill travelling. In addition, in the process of hill parking control of the vehicle, the actual weight of the vehicle may be continuously updated to provide auxiliary conditions and reference data for hill parking control of each vehicle.

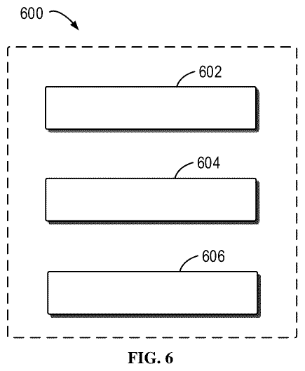

FIG. 6 shows a block diagram of a device 600 for controlling hill parking of the vehicle according to some examples of the present disclosure. With reference to FIG. 6, the device 600 comprises a torque determination unit 602 configured to determine a torque for controlling the vehicle based on a weight of the vehicle and an angle of a hill on which the vehicle is located. The device 600 further comprises a torque request generation unit 604 configured to generate a torque request for a first drive motor of the vehicle and a zero rotational speed control request for a second drive motor of the vehicle based on the torque. The device 600 further comprises a hill parking control unit 606 configured to control hill parking of the vehicle with the first drive motor and the second drive motor in response to the torque request and the zero rotational speed control request.

In some examples, the device 600 further comprises a weight updating unit configured to: obtain a first torque output from a first drive motor and a second torque output from a second drive motor; determine a total torque based on the first torque and the second torque; update a weight of the vehicle and store an updated weight based on the total torque and the accelerated speed of the vehicle.

In some examples, the weight updating unit is further configured to: determine a component of the corresponding gravitational accelerated speed of the vehicle in the hill direction based on the angle of the hill; and update the weight of the vehicle and store the updated weight based on the total torque, the accelerated speed of the vehicle, and the component of the gravitational accelerated speed.

In some examples, the weight updating unit is further configured to: obtain the initial accelerated speed of the vehicle during startup on the hill; and update the weight of the vehicle and store the updated weight based on the total torque, the torque, the initial accelerated speed, and the accelerated speed.

In some examples, the torque determination unit 602 is further configured to: determine a first torque required to be provided by the first drive motor based on the preset distribution coefficient and the torque; and generate a torque request for the first drive motor based on the first torque.

In some examples, the hill parking control unit 606 is further configured to: control the first torque output by the first drive motor in response to the torque request; control the second drive motor to perform zero rotational speed control to output the second torque in response to the zero rotational speed control request; and control hill parking of the vehicle based on the first torque and the second torque.

In some examples, the torque determination unit 602 is further configured to: determine the gravity borne by the vehicle based on the weight of the vehicle and the angle of the hill on which the vehicle is located; determine the torque for controlling the vehicle based on the component of the gravity in the hill direction.

In some examples, the device 600 further comprises a hill angle determination unit configured to: obtain a pitch angle of the vehicle and an initial accelerated speed of the vehicle during startup on the hill; and determine an angle of the hill based on the pitch angle and the initial accelerated speed.

In some examples, the device 600 further comprises an exception alert unit configured to: obtain an accelerated speed of the vehicle after utilizing the first drive motor and the second drive motor to control hill parking of the vehicle; and return an exception alert message in response to the accelerated speed being greater than a preset accelerated speed threshold.

It will be understood that the device 600 of the present disclosure may achieve at least one of a number of advantages that the method or process described above can achieve. For example, two drive motors can be used by the device 600 to provide a greater range of drive force for hill parking of the vehicle to ensure that when the vehicle is in a heavy-loaded (or overloaded) state or the vehicle is in a skewed hill, sufficient drive forces can also be provided to the vehicle to prevent vehicle slipping, thereby further increasing the safety and convenience of the vehicle during startup in the hill environment and improving the safety of vehicle during hill driving. At the same time, because the drive modes of the two drive motors are different, there will be no conflict in the control of the vehicle, thereby avoiding increasing the slip distance of the vehicle on the hill and ensuring the safety during hill driving.

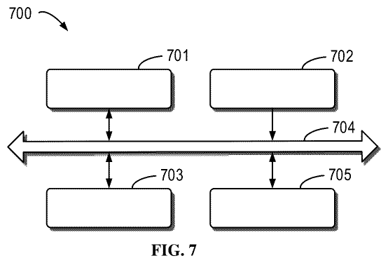

FIG. 7 shows a schematic block diagram of an example apparatus 700 that can be used to implement examples of the present disclosure. As shown in FIG. 7, the appliance 700 comprises a processor 701, which can perform various appropriate actions and processes according to computer program instructions stored in a read only memory (ROM) 702 and loaded into a random access memory (RAM) 703. Various programs and data required for the operation of the apparatus 700 can also be stored in the RAM 703. The processor 701, the ROM 702, and the RAM 703 are interconnected through a bus 704. An input/output (I/O) interface 705 is also connected to the bus 704.

The various processes and processing described above, such as the method 200, may be executed by the processor 701. For example, in some examples, the method 200 can be implemented as a computer software program tangibly contained in a machine-readable medium. In some examples, a part or all of the computer programs may be loaded and/or installed onto the apparatus 700 via the ROM 702. When the computer program is loaded onto the RAM 703 and executed by the processor 701, one or more actions of the method 200 described above may be performed.

The present disclosure may be a method, device, system and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: random access memory (RAM), read-only memory (ROM), wipeable programmable read-only memory (EPROM or flash memory), static random access memory (SRAM), and any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is capable of executing computer-readable program instructions, thereby achieving the various aspects of the present disclosure.

Various aspects of the present disclosure are described herein with reference to flow charts and/or block diagrams depicting methods, device (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers or the processing units of other programmable data processing devices, thereby producing a type of machine, such that when these instructions are executed by the computers or processing units of other programmable data processing devices, an apparatus that realizes the functions/actions stipulated in one or more boxes in the flow charts and/or block diagrams is produced. These computer-readable program instructions may also be stored in computer-readable storage medium, enabling computers, programmable data processing devices, and/or other devices to operate in a specific manner. Therefore, the computer-readable media containing instructions comprise a manufactured product that comprises instructions for implementing various aspects of the functions/actions specified in one or more boxes in the flow charts and/or block diagrams.

The computer-readable program instructions may also be loaded onto a computer, other programmable data processing devices, or other devices, enabling a series of operational steps to be executed on the computer, other programmable data processing devices, or other devices to generate a computer-implemented process. This enables the instructions executed on the computer, other programmable data processing devices, or other devices to implement the functions/actions specified in one or more boxes in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used herein aims to best explain the principles and actual applications of various examples as well as the technological improvements in the technology in the market, or allow others of ordinary skill in the art to understand various examples disclosed herein.

What is claimed is:

1. A method for controlling hill parking of a vehicle, comprising:
determining a torque for controlling the vehicle based on a weight of the vehicle and an angle of a hill on which the vehicle is located;
generating a torque request for a first drive motor of the vehicle and a zero rotational speed control request for a second drive motor of the vehicle based on the torque; and
controlling hill parking of the vehicle with the first drive motor and the second drive motor in response to the torque request and the zero rotational speed control request.

2. The method according to claim 1, further comprising:
obtaining a first torque output from the first drive motor and a second torque output from the second drive motor;
determining a total torque based on the first torque and the second torque; and
updating the weight of the vehicle and storing the updated weight based on the total torque and an accelerated speed of the vehicle.

3. The method according to claim 2, wherein updating the weight of the vehicle and storing the updated weight based on the total torque and the accelerated speed of the vehicle comprise:
determining a component of a corresponding gravitational accelerated speed of the vehicle in a hill direction based on the angle of the hill; and
updating the weight of the vehicle and storing the updated weight based on the total torque, the accelerated speed of the vehicle, and the component of the gravitational accelerated speed.

4. The method according to claim 2, wherein updating the weight of the vehicle and storing the updated weight based on the total torque and the accelerated speed of the vehicle comprise:
obtaining an initial accelerated speed of the vehicle during startup on the hill; and
updating the weight of the vehicle and storing the updated weight based on the total torque, the torque, the initial accelerated speed, and the accelerated speed.

5. The method according to claim 1, wherein generating the torque request for the first drive motor of the vehicle based on the torque comprises:
determining a first torque required to be provided by the first drive motor based on a preset distribution coefficient and the torque; and
generating the torque request for the first drive motor based on the first torque.

6. The method according to claim 1, wherein controlling hill parking of the vehicle with the first drive motor and the second drive motor in response to the torque request and the zero rotational speed control request comprises:
controlling a first torque output by the first drive motor in response to the torque request;
controlling the second drive motor to conduct zero rotational speed control to output a second torque in response to the zero rotational speed control request; and
controlling hill parking of the vehicle based on the first torque and the second torque.

7. The method according to claim 1, wherein determining the torque for controlling the vehicle based on the weight of the vehicle and the angle of the hill on which the vehicle is located comprises:
determining a gravity borne by the vehicle based on the weight of the vehicle and the angle of the hill on which the vehicle is located; and
determining the torque for controlling the vehicle based on a component of the gravity in the hill direction.

8. The method according to claim 1, further comprising:
obtaining a pitch angle of the vehicle and an initial accelerated speed of the vehicle during startup on the hill; and
determining the angle of the hill based on the pitch angle and the initial accelerated speed.

9. The method according to claim 1, further comprising:
obtaining an accelerated speed of the vehicle after controlling hill parking of the vehicle with the first drive motor and the second drive motor; and
returning an exception alert message in response to the accelerated speed being greater than a preset accelerated speed threshold.

10. A device for controlling hill parking of a vehicle, comprising:
a torque determination unit configured to determine a torque for controlling the vehicle based on a weight of the vehicle and an angle of a hill on which the vehicle is located;
a torque request generation unit configured to generate a torque request for a first drive motor of the vehicle and a zero rotational speed control request for a second drive motor of the vehicle based on the torque; and
a hill parking control unit configured to control hill parking of the vehicle with the first drive motor and the second drive motor in response to the torque request and the zero rotational speed control request.

11. A controller, comprising:
at least one processor; and
a memory, coupled to the at least one processor, and having instructions stored thereon, the instructions, when executed by the at least one processor, causing the controller to perform the method according to claim 1.

12. A vehicle, comprising the controller according to claim 11.

13. A computer program product, the computer program product being tangibly stored on a non-volatile computer-readable medium and comprising machine-executable instructions, the machine-executable instructions, when executed, causing a machine to execute steps of the method according to claim 1.
